(19) United States
(12) Patent Application Publication
(10) Pub. No.: US 2014/0256366 A1
(43) Pub. Date: Sep. 11, 2014

(54) Network Traffic Control via SMS Text Messaging

(71) Applicant: BARRACUDA NETWORKS, INC., Campbell, CA (US)

(72) Inventor: Klaus M. Gheri, Innsbruck (AT)

(73) Assignee: BARRACUDA NETWORKS, INC., Campbell, CA (US)

(21) Appl. No.: 13/907,817

(22) Filed: Jun. 3, 2013

Related U.S. Application Data
(60) Provisional application No. 61/773,259, filed on Mar. 6, 2013.

(51) Int. Cl. H04W 4/14

(52) U.S. Cl. CPC H04W 4/14
USPC 455/466

(57) ABSTRACT

A wireless device is communicatively coupled via SMS text protocol to a network control device by a data modem. Authentication of the operator enables a limited number of fixed operations such as status reports, initializing a new network connection, and modifications to a routing table to be carried out.

### RELATED APPLICATIONS

NONE.

### BACKGROUND

The area of the invention is in controlling the operation of data communication devices remotely under a failure condition.

Motivation: To solve the long standing and prohibitively costly problem of remotely altering the behavior of a TCP/IP network control device when it is no longer accessible via the TCP/IP network itself. When a conventional network control device requires service, one common resolution is to physically access its control panel. But, increasingly, network control devices are managed remotely. When the network control device is erratic or inaccessible from the network it becomes more expensive to dispatch a service representative to physically access the equipment.

Because conventional (prior art) futile solutions (such as modem dial-up) did not, could not, and would not be efficiently operable from anywhere in the world with sufficient security safeguards, it can be appreciated that what is needed is an improved apparatus and method which a. can be usable from standard handheld communication equipment such as mobile phones, b. can retrieve system feedback without synchronous system level access, and c. can be provisioned with a denial-of-service protection feature.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a wireless mobile device communicatively coupled by SMS to a network control device.

### SUMMARY OF THE INVENTION

A system which includes one of a 3G/GSM/4G/LTE wireless data communication network, at least one mobile wireless device coupled to the wireless data communication network, a processor coupled to the 3G/GSM/4G/LTE network via a data modem, a counter, computer readable storage, and software to authenticate control messages from a remote operator, trigger predefined actions appropriate to the authority of the remote operator and send confirmation and/or status messages back to the remote operator, wherein said counter can be reset after a configurable maximum number sent text message commands via a separate management access to the equipment controlling the traffic flow.

A network control circuit is coupled to an Short Message Service (SMS) transceiver. A mobile wireless device is configured with an SMS Application (SMS App) and a Command Authentication Application (CA App). The network control circuit receives a first SMS message from the mobile wireless device and returns a time-limited codeword. The network control circuit receives a second SMS message from the mobile wireless device, authenticates it, and initiates a sequence of stored commands. The CA App provides a hashing of an operator supported password, the MAC address of the wireless device, a selected command and uses the time-limited codeword as a seed or a suffix.

### DETAILED DISCLOSURE OF EMBODIMENTS

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

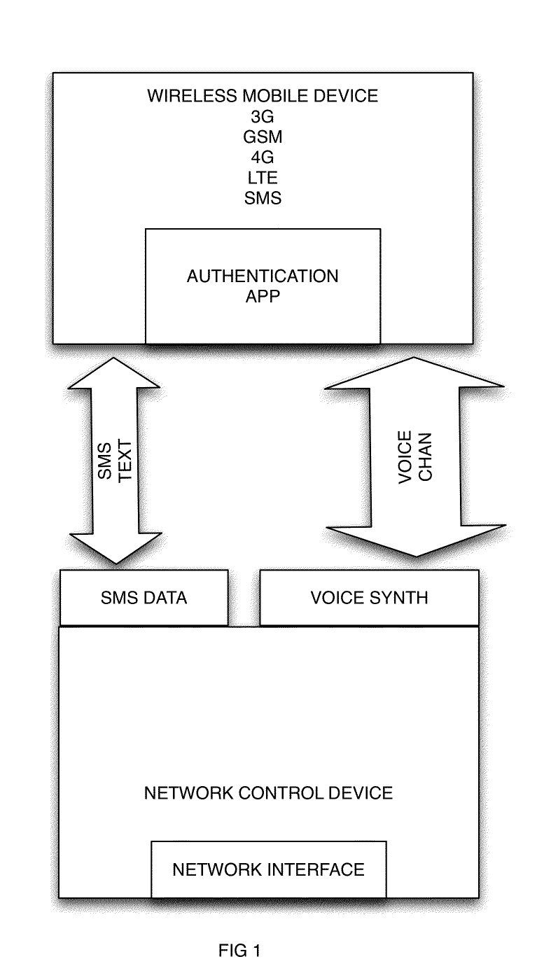

Referring to FIG. 1, a Short Message System (SMS) channel connects a wireless mobile device to a network control circuit or network control device. Certain commands may be sent by certain authorized users on certain wireless mobile devices to restart, restore, or reconfigure a network control device when the TCP/IP network interface is unreliable. Traffic in the SMS channel is hashed or encrypted for security. A token code may be generated for a specific wireless mobile device upon request which is valid for a period of time. An app on the wireless mobile device receives a token code and uses it to encode or encrypt an authenticated command by using the token code as a seed in a hash or a suffix to a command which combines the MAC address or IMEI address or both.

In an embodiment codes and commands are encrypted and transmitted in binary SMS format. In embodiments one such sequence of stored commands opens a reverse SSL tunnel to a service center server and exchange authentication certificates. Another sequence of commands restores from a known good recovery storage device. Another sequence of commands power cycles certain equipment. Another sequence of command modifies a routing table.

In addition we disclose a method for operating the above apparatus comprising steps/processes—the apparatus polls the GSM/3G modem periodically for incoming text messages. Text messages are read out along with the sender's phone number. If the sender's phone number is part of an access control list processing continues. The message is parsed and expected to contain an instruction label and a matching codeword. The instruction label identifies the instruction to be carried out. The instruction itself is not sent along with the text message. Next the codeword is checked to match the codeword assigned to the particular instruction label. The check is based on creating an MD5 hash and comparing the MD5 hash with the one stored on the apparatus for that particular instruction enabled for a certain time range. If the codeword mismatches; the processing stops. If it matches, a successive command counter is incremented and checked against a configured limit. If the configured limit has been reached the request is dropped and a matching confirmation is sent back to the original phone number.

If the limit has not been reached the successive command counter is incremented and the command matching the instruction label is carried out.

The instruction can now bring up a new network connection and alter the flow of network traffic through the device by modifying the routing table. A confirmation message is sent back to the requestor.

In an embodiment, the apparatus is equipped with a voice synthesizer and dials back the sender's phone number with a synthesized random seed valid within a timelimit. The operator uses an app installed on the wireless device to generate the codeword appropriate to that wireless device for a limited time.

In an embodiment, the wireless device uses its camera to capture and compare an image for authentication of the remote operator. In an embodiment, the GPS location of the mobile wireless device is transmitted to further authenticate the operator.

One aspect of the invention is a system including

a wireless mobile device coupled to a 3G/GSM/4G/LTE communications network, communicatively coupled to a data modem, coupled to a processor of a network control device, and computer-readable storage encoded with instructions which when executed by the processor cause to authenticate the operator of the wireless mobile device and execute a limited number of fixed operations.

An other aspect of the invention is a method for operation of a network control circuit communicatively coupled to a Short Message Service interface, which includes the processes of receiving and authenticating an SMS message from a wireless device requesting a token code; generating and storing a first token code for the requesting wireless device which token code shall be valid for a range of time; transmitting said generated token code to said requesting wireless device; receiving an SMS message from the wireless device comprising an authenticated command; verifying the authenticated command with the stored token code and the IMEI and MAC addresses stored for the wireless device; and upon successful verification, initiating a sequence of processes.

In an embodiment, the sequence of processes includes the processes: opening a reverse SSL tunnel with a service center server.

In an embodiment, the sequence of processes comprises: modifying a routing table. In an embodiment, the sequence of processes comprises: initiating a restoration of system files and configuration from a known good non-transitory recovery store. In an embodiment, the authenticated command is verified by hashing the MAC address of the wireless device with a command code selected by the user input. In an embodiment, the authenticated command is verified by concatenating the token code generated by the network control circuit with the MAC address of the wireless device with a command code selected by the user input. In an embodiment, the authenticated command is verified by hashing the token code generated by the network control circuit with the MAC address of the wireless device with a command code selected by the user input. In an embodiment, the token code is a binary SMS message. In an embodiment, the authenticated command is a binary SMS message.

An other aspect of the invention is a method for operation of a wireless mobile device having a Short Message System Application (SMS App) and a Command Authentication Application (CA App), which includes receiving selection of an SMS destination and request for token code from user input; transmitting the request for token code to a first SMS destination by operating the SMS App; receiving a token code generated by a network control circuit by operating the SMS App; and generating an authenticated command by operating the CA App; and transmitting the authenticated command to a second SMS destination by operating the SMS App, whereby the network control circuit initiates a sequence of processes. In an embodiment, the sequence of processes comprises: opening a reverse SSL tunnel with a service center server. In an embodiment, the sequence of processes comprises: modifying a routing table. In an embodiment, the sequence of processes comprises: initiating a restoration of system files and configuration from a known good non-transitory recovery store. In an embodiment, the authenticated command is generated by hashing the MAC address of the wireless device with a command code selected by the user input. In an embodiment, the authenticated command is generated by concatenating the token code generated by the network control circuit with the MAC address of the wireless device with a command code selected by the user input. In an embodiment, the authenticated command is generated by hashing the token code generated by the network control circuit with the MAC address of the wireless device with a command code selected by the user input. In an embodiment, the token code is a binary SMS message.

In an embodiment, the authenticated command is a binary SMS message. In an embodiment, the method further comprises receiving a user input password to request a token code and receiving a user input password to generate an authenticated command.

In an embodiment, IMEI and MAC are available locally to the auth app on the mobile device and are used a secret tokens to validate any request as the phone number itself is not trustworthy. For any authorized mobile devices these identification tokens must also be stored on the network device itself so that the appropriate checks can be carried out.

In an embodiment, only the privileged network administrator may install the Command Authentication App installed on a certain approved mobile device and its MAC and IMEI are stored at the network device. The App will read and use MAC and IMEI from the mobile device which is stored at the network device to generate an Authenticated Command. Only certain few commands are enabled to be initiated from the privileged network administrator's mobile device and those commands are verified using the MAC and IMEI stored at the network device.

### CONCLUSION

The present invention can be easily distinguished from conventional remote login via dialup modem by its use of the Short Messaging System infrastructure to transmit limited instructions and receive limited status reports. It can be further distinguished by authentication apps installed on the mobile wireless device. The network control device can be configured to only accept certain IMEI and certain MAC addresses which are accessible to the authentication app.

It can be further distinguished by use of synthesized voice to ensure that the source of the SMS transmission is not being spoofed. It can be further distinguished by binary SMS messages which can support encrypted transmissions.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry. A number of embodiments of the invention have been described. Nevertheless, it will be understood that various modifications may be made without departing from the spirit and scope of the invention. For example, other network topologies may be used. Accordingly, other embodiments are within the scope of the following claims.

I claim:

1. A system comprising
a wireless mobile device coupled to a 3G/GSM/4G/LTE communications network, communicatively coupled to
a data modem; the data modem coupled to
a processor of a network control device; and
computer-readable storage encoded with instructions which when executed by the processor cause to authenticate the operator of the wireless mobile device and execute a limited number of fixed operations.

2. A method for operation of a network control circuit communicatively coupled to a Short Message Service interface, the method comprising:
receiving and authenticating an SMS message from a wireless device requesting a token code;
generating and storing a first token code for the requesting wireless device which token code shall be valid for a range of time;
transmitting said generated token code to said requesting wireless device;
receiving an SMS message from the wireless device comprising an authenticated command;
verifying the authenticated command with the stored token code and the IMEI and MAC addresses stored for the wireless device; and
upon a condition of successful verification, initiating a sequence of processes.

3. The method of claim 2 wherein the sequence of processes comprises:
opening a reverse SSL tunnel with a service center server.

4. The method of claim 2 wherein the sequence of processes comprises:
modifying a routing table.

5. The method of claim 2 wherein the sequence of processes comprises:
initiating a restoration of system files and configuration from a known good non-transitory recovery store.

6. The method of claim 2 wherein the authenticated command is verified by
hashing the MAC address of the wireless device with a command code selected by the user input.

7. The method of claim 2 wherein the authenticated command is verified by
concatenating the token code generated by the network control, circuit with the MAC address of the wireless device with a command code selected by the user input.

8. The method of claim 2 wherein the authenticated command is verified by
hashing the token code generated by the network control, circuit with the MAC address of the wireless device with a command code selected by the user input.

9. The method of claim 11 wherein the token code is a binary SMS message.

10. The method of claim 11 wherein the authenticated command is a binary SMS message.

11. A method for operation of a wireless mobile device having a Short Message System Application (SMS App) and a Command Authentication Application (CA App), the method comprising:
receiving selection of an SMS destination and request for token code from user input;
transmitting the request for token code to a first SMS destination by operating the SMS App;
receiving a token code generated by a network control circuit by operating the SMS App; and
generating an authenticated command by operating the CA App; and
transmitting the authenticated command to a second SMS destination by operating the SMS App, whereby the network control circuit initiates a sequence of processes.

12. The method of claim 11 wherein the sequence of processes comprises:
opening a reverse SSL tunnel with a service center server.

13. The method of claim 11 wherein the sequence of processes comprises:
modifying a routing table.

14. The method of claim 11 wherein the sequence of processes comprises:
initiating a restoration of system files and configuration from a known good non-transitory recovery store.

15. The method of claim 11 wherein the authenticated command is generated by
hashing the MAC address of the wireless device with a command code selected by the user input.

16. The method of claim 11 wherein the authenticated command is generated by
concatenating the token code generated by the network control circuit with the MAC address of the wireless device with a command code selected by the user input.

17. The method of claim 11 wherein the authenticated command is generated by
hashing the token code generated by the network control circuit with the MAC address of the wireless device with a command code selected by the user input.

18. The method of claim 11 wherein the token code is a binary SMS message.

19. The method of claim 11 wherein the authenticated command is a binary SMS message.

20. The method of claim 11 further comprising
receiving a user input password to request a token code; and
receiving a user input password to generate an authenticated command.
